(19) United States
(12) Patent Application Publication
(10) Pub. No.: US 2007/0124051 A1
(43) Pub. Date: May 31, 2007

(54) Vehicle drive control system and method

(75) Inventor: Yoshitaka Fujita, Susono-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, TOYOTA-SHI (JP)

(21) Appl. No.: 11/603,988

(22) Filed: Nov. 24, 2006

(30) Foreign Application Priority Data
Nov. 28, 2005 (JP) 2005-342328

(51) Int. Cl. G06G 7/76

(52) U.S. Cl. 701/70

(57) ABSTRACT

A drive control system for a vehicle includes a braking force control mechanism that controls braking forces on the wheels of the vehicle according to a braking operation, a steering characteristic control mechanism that varies the steering characteristic of the vehicle, a determination portion that determines whether an emergency steering operation is likely to de performed when hard braking is being applied, and a main control portion that controls the steering characteristic control mechanism so as to vary the steering characteristic of the vehicle to increase oversteering component of the vehicle if the determination portion determines that an emergency steering operation is likely to be performed.

### INCORPORATION BY REFERENCE

The disclosure of Japanese Patent Application No. 2005-342328 filed on Nov. 28, 2005 including the specification, drawings and abstract is incorporated herein by reference in its entirety.

### BACKGROUND OF THE INVENTION

1. Field of the Invention

The invention relates to a vehicle drive control system and method, and more particularly, to a vehicle drive control system and method for controlling the steering characteristic of the vehicle when hard braking is being applied by the driver.

2. Description of the Related Art

One of the conventional vehicle drive control systems for vehicles such as automobiles is disclosed in JP-A-9-263233. This vehicle drive control system performs brake assist control in which additional brake pressures are produced when the driver is applying hard braking, so that the ratio of the braking force to the amount of the braking operation by the driver increases.

When very large braking forces are being applied to the wheels, such as during the brake assist control, the forces produced at the wheels, particularly at the front wheels, are mainly used to brake the vehicle, and therefore the amount of lateral force that can be produced at the front wheels is relatively small, which makes it difficult for the driver to turn the vehicle as he or she intends.

However, the difficulty in turning the vehicle as intended by the driver's steering operation under the brake assist control has not been addressed in the conventional drive control systems. As such, there are demands for an improved drive control system which copes with not only hard braking required by the driver, but also turning of the vehicle as much as intended by the driver.

### SUMMARY OF THE INVENTION

It is an abject of the invention to enable a driver of a vehicle to turn the vehicle as he or she intends while hard braking is being applied to the vehicle.

A first aspect of the invention relates to a drive control system for a vehicle, including: a braking force control mechanism that controls at least braking forces on steered wheels according to a braking operation; a steering characteristic control mechanism that varies a steering characteristic of the vehicle; a determination portion that determines whether an emergency steering operation is likely to be performed when hard braking is being applied; and a main control portion that controls the steering characteristic control mechanism so as to vary the steering characteristic of the vehicle to increase oversteering component of the vehicle if the determination portion determines that an emergency steering operation is likely to be performed.

According to this structure, a determination is made whether hard braking is being applied by, for example, a driver of the vehicle, and if so, a determination is then made whether emergency steering operation is likely to be performed by, for example, the driver. If it is determined that an emergency steering operation is likely to be performed, the steering characteristic control mechanism is controlled to vary the steering characteristic of the vehicle to increase oversteering component of the vehicle so that it becomes greater than it is when the likelihood of an emergency steering operation is low, whereby the driver can turn the vehicle easily during the hard braking. As such, for example, when the driver performs an emergency steering operation during bard braking, the vehicle can be turned as much as the driver intends while being braked as required.

The steering characteristic control mechanism may include a roll stiffness allocation control mechanism that changes a roll stiffness allocation between front wheels and rear wheels of the vehicle. If the determination portion determines that an emergency steering operation is likely to be performed, the main control portion may control the roll stiffness allocation control mechanism so that the roll stiffness allocation is biased towards the rear wheels, as compared to when the determination portion determines that an emergency steering operation is not likely to be performed.

According to this structure, for example, when the likelihood of an emergency steering operation by the driver is high while the driver is applying hard braking, the steering characteristic of the vehicle can be reliably varied to increase oversteering component of the vehicle so that it becomes greater than it is when the likelihood is low.

The roll stiffness allocation control mechanism may include a front stabilizer that applies a torsional stress to the front wheels and is capable of changing the magnitude of the torsional stress to the front wheels and a rear stabilizer that applies a torsional stress to the rear wheels and is capable of changing the magnitude of the torsional stress to the rear wheels. The control portion may bias the roll stiffness allocation towards the rear wheels by reducing the torsional stress to the front wheels through control of the front stabilizer.

According to this structure, for example, when the likelihood of an emergency steering operation is high, the roll stiffness allocation is biased towards the rear wheels, as compared to when the likelihood is low.

The steering characteristic control mechanism may include damping force changing devices provided for the front and rear wheels, respectively. When the determination portion determines that an emergency steering operation is likely to be performed, the main control portion may control the damping force changing device provided for the front wheel on the outside of a turn of the vehicle so as to make a damping coefficient for the same front wheel smaller than it is when the determination portion determines that an emergency steering operation is not likely to be performed.

According to this structure, compared to the case where the damping coefficient for the outside front wheel is not reduced, the vehicle height at the outside front wheel is lowered, and therefore the difference in height between the roll center at the front wheels and the center of gravity of the vehicle increases. Thus, if the vehicle is turned in this state, a larger roll moment occurs at the front wheels, which increases the vertical load of the outside front wheel and reduces the vertical load of the inside front wheel, thus enabling a larger amount of lateral force to be produced at the outside front wheel. The larger roll moment at the front wheels also reduces the braking force on the inside front wheel and thus causes a difference in braking force between the left and right front wheels, which causes a yawing moment to occur in the direction to assist the vehicle to turn. Thus, the driver can steer the vehicle more easily during turning of the vehicle, especially in the initial stage of the steering operation.

In another form of the invention, the main control portion may be configured to control the steering characteristic control mechanism so as to increase the amount by which the steering characteristic of the vehicle is varied to increase oversteering component of the vehicle as the likelihood of an emergency steering operation increases.

In another form of the invention, the determination portion may be configured to determine the likelihood of an emergency steering operation by a driver based on the rate of increase in the amount of braking operation by the driver.

In another form of the invention, the determination portion may be configured to calculate an index value indicating the likelihood of an emergency steering operation by a driver based on the rate of increase in the amount of braking operation by the driver, and the main control portion may be configured to control the steering characteristic control mechanism so as to increase the amount by which the steering characteristic of the vehicle is varied to increase oversteering component of the vehicle as the index value increases.

In another form of the invention, the main control portion may be configured to control the roll stiffness allocation control mechanism so as to increase the amount by which the roll stiffness allocation between the front wheels and the rear wheels is biased towards the rear wheels as the likelihood of an emergency operation by a driver increases.

In another form of the invention, the main control portion may be configured to bias the roll allocation between the front wheels and the rear wheels towards the rear wheels by reducing the torsional stress applied from the front stabilizer to the front wheels and increasing the torsional stress applied from the rear stabilizer to the rear wheels.

In another form of the invention, the main control portion may be configured to control, when the likelihood of an emergency steering operation by a driver is high, the damping force changing devices so as to make the damping coefficients for the front wheels smaller than they are when the likelihood of an emergency steering operation by the driver is low.

In another form of the invention, the main control portion may be configured to control, when the likelihood of an emergency steering operation by a driver is high, the damping force changing devices so as to make a compression damping coefficient for the front wheel on the outside of the turn of the vehicle smaller and make an extension damping coefficient for the front wheel on the inside of the turn of the vehicle smaller than they are when the likelihood of an emergency steering operation by the driver is low.

In another form of the invention, the main control portion may be configured to control, when the likelihood of an emergency steering operation by a driver is high, the damping force changing devices so as to make the damping coefficient for the rear wheel on the outside of the turn of the vehicle larger than it is when the likelihood of an emergency steering operation by the driver is low.

In another form of the invention, the main control portion may be configured to control, when the likelihood of an emergency steering operation by a driver is high, the damping force changing devices so as to make a compression damping coefficient for the rear wheel on the outside of the turn of the vehicle larger and make an extension damping coefficient for the rear wheel on the inside of the turn of the vehicle larger than they are when the likelihood of an emergency steering operation by the driver is low.

In another form of the invention, the main control portion may be configured to activate brake assist control in response to hard braking being applied by a driver, and the determination portion may be configured to make the determination as to the likelihood of an emergency steering operation by a driver during the brake assist control.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a schematic diagram of a vehicle drive control system according to the first embodiment of the invention, which is applied to a vehicle having front and rear active stabilizers;

FIG. 2 is a flowchart of a braking force control routine according to the first embodiment;

FIG. 3 is a graph representing a relationship between the duration Tba of the brake assist control and the target additional pressures ΔPcft and ΔPcrt;

FIG. 4 is a flowchart of a control routine for controlling the roll stiffness and damping forces according to the first embodiment;

FIG. 5 is a graph representing a relationship between the increasing rate ΔPm of master cylinder pressure and the index value Ks indicating the likelihood of emergency steering operation;

FIG. 6 is a graph representing a relationship between the index value Ks and the target roll stiffness allocation amount Rsft to the front wheels;

FIGS. 7A and 7B are graphs regarding the outside front wheel and the inside front wheel, each representing a relationship among the wheel stroke speed, the index value Ks, and the damping force;

FIGS. 8A and 8B are graphs regarding the outside rear wheel and the inside rear wheel, each representing a relationship among the wheel stroke speed, the index value Ks, and the damping force;

FIG. 9 is a schematic diagram of a vehicle drive control system according to the second embodiment of the invention, which is applied to a vehicle having front and rear active stabilizers;

FIG. 10 is a flowchart of a control routine for controlling the roll stiffness and damping forces according to the second embodiment; and

FIG. 11 is a graph representing a relationship between the potential time Tc before the vehicle collides with an obstacle and the correction coefficient Ka.

### DETAILED DESCRIPTION OF THE EXEMPLARY EMBODIMENTS

With reference to the accompanying drawings, several exemplary embodiments of the preset invention will be described in detail below.

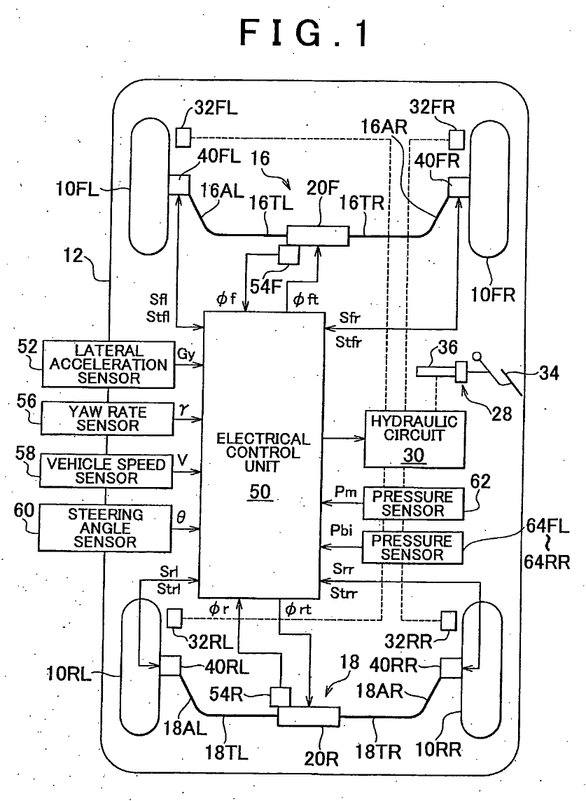

FIG. 1 is a schematic diagram of a vehicle drive control system according to the first embodiment of the invention, which is applied to a vehicle having front and rear active stabilizers.

In FIG. 1, reference numerals 10FL and 10FR denote left and right front wheels of a vehicle 12 as driven wheels, respectively, and reference numerals 10RL and 10RR denote left and right rear wheels of the vehicle 12 as drive wheels, respectively. The left and right front wheels 10FL and 10FR, which are also steered wheels, are steered via tie rods by a power steering apparatus (not shown) that is driven in response to a steering wheel (not shown) being operated by the driver.

An active stabilizer 16 is provided between the left and right front wheels 10FL and 10FR. An active stabilizer 18 is provided between the left and right rear wheels 10RL and 10RR. The active stabilizer 16 has a pair of torsion bars 16TL and 16TR, which extend coaxially to each other with the axis extending in the lateral direction of the vehicle, and a pair of arms 16AL and 16AR, which are connected integrally with the respective outer ends of the torsion bars 16TL and 6TR. The torsion bars 16TL and 16TR are supported by a vehicle body (not shown) via respective brackets (not shown) so that the torsion bars can rotate about their own axes. The arms 16AL and 16AR extend nearly perpendicular to the torsion bars 16TL and 16TR, i.e. in the longitudinal direction of the vehicle. The respective outer ends of the arms 16AL and 16AR are coupled with wheel support members or suspension arms of the left and right front wheels 10FL and 10FR through rubber bushes (not shown).

The active stabilizer 16 has an actuator 20F between the torsion bars 16TL and 16TR. The actuator 20F rotates the pair of torsion bars 16TL and 16TR as needed in the opposite directions to each other and thereby changes the torsional stress that is applied to the front wheels 10FL and 10FR from the active stabilizer 16 to damp bounding and rebounding motion of the left and right front wheels 10FL and 10FR in opposite phases. That is, as the torsional stress of the active stabilizer 16 changes, the anti-roll moment at the left and right front wheels 10FL and 10FR of the vehicle changes accordingly. Thus, by changing the torsional stress by means of the actuator 20F, the active stabilizer 16 variably controls the roll stiffness of the vehicle on the front wheel side.

Likewise, the active stabilizer 18 has a pair of torsion bars 18TL and 18TR, which extend coaxially to each other with the axis extending in the lateral direction of the vehicle, and a pair of arms 18AL and 18AR, which are connected integrally with the respective outer ends of the torsion bars 18TL and 18TR. The torsion bars 18TL and 18TR are supported by a vehicle body (not shown) via respective brackets (not shown) so that the torsion bars can rotate about their own axes. The arms 18AL and 18AR extend nearly perpendicular to the torsion bars 18TL and 18TR, i.e. in the longitudinal direction of the vehicle. The respective outer ends of the arms 18AL and 18AR are coupled with wheel support members or suspension arms of the left and right rear wheels 10RL and 10RR through rubber bushes (not shown).

The active stabilizer 18 has an actuator 20R between the torsion bars 18TL and 18TR. The actuator 20R rotates the pair of torsion bars 18TL and 18TR as needed in the opposite directions to each other and thereby changes the torsional stress that is applied to the rear wheels 10RL and 10RR from the active stabilizer 18 to damp bounding and rebounding motion of the left and right rear wheels 10RL and 10RR in opposite phases. That is, as the torsional stress of the active stabilizer 18 changes, the anti-roll moment at the left and right rear wheels 10RL and 10RR of the vehicle changes accordingly. Thus, by changing the torsional stress by means of the actuator 20R, the active stabilizer 18 variably controls the roll stiffness of the vehicle on the rear wheel side.

Because the active stabilizers 16 and 18 are not the principal subject of the invention, any construction known in the art may be employed for a stabilizer which can variably control the vehicle roll stiffness. For example, the active stabilizer 16 or 18 may have: an electric motor that is fixed to the inner end of one of the torsion bars and has a rotational shaft on which a drive gear is mounted; and a driven gear that is fixed to the inner end of the other torsion bar and meshes with the drive gear, so that the rotation of the drive gear is transmitted to the driven gear, while the rotation of the driven gear is not transmitted to the drive gear. An example of such active stabilizer is disclosed in JP-A-2005-88722 related to the application of this applicant.

As shown in FIG. 1, braking forces on the left and right front wheels 10FL and 10FR and on the left and right rear wheels 10RL and 10RR are controlled by a hydraulic circuit 30 of a brake system 28, which regulates the brake pressures of wheel cylinders 32FL, 32FR, 32RL and 32RR associated with the respective wheels. The hydraulic circuit 30 includes a reservoir, an oil pump, and various valve devices, although they are not shown in the drawings. Normally, the brake pressure of each wheel cylinder is controlled according to the operation amount of a brake pedal 34 and the pressure of a master cylinder 36 that is driven in response to the operation of the brake pedal 34. If needed, the brake pressure of each wheel cylinder is controlled by controlling the oil pump and various valve devices, independent of the amount by which the brake pedal 34 is operated by the driver.

According to the illustrated first embodiment, the left and right front wheels 10FL and 10FR and the left and right rear wheels 10RL and 10RR are provided with variable damping force shock absorbers 40FL, 40FR, 40RL and 40RR, respectively. These shock absorbers may employ any construction known in the art. The damping coefficient of each shock absorber 40FL to 40RR can be varied in n (positive integer) stages from the minimum stage Smin to the maximum stage Smax by an actuator (not shown in FIG. 1).

As shown in FIG. 1, an electrical control unit (ECU) 50 controls the actuators 20F and 20R of the active stabilizers 16 and 18, the oil pump, and the various valve devices of the brake system 28, and actuators of the shock absorbers 40FL to 40RR. The ECU 50 may be formed by a drive circuit and a micro computer including a CPU, ROM, RAM and input/output ports, which are all connected to each other via a bi-directional common bus, although they are not shown in detail in FIG. 1.

As shown in FIG. 1, the ECU 50 receives a signal indicative of vehicle lateral acceleration Gy from a lateral acceleration sensor 52, and signals indicative of actual rotational angles f f and f r of the actuators 20F and 20R, which are detected by rotational angle sensors 54F and 54R. The ECU 50 also receives: a signal indicative of vehicle yaw rate γ detected by a yaw rate sensor 56; a signal indicative of a vehicle speed V detected by a vehicle speed sensor 58; a signal indicative of a steering angle θ detected by a steering angle sensor 60; a signal indicative of a master cylinder pressure Pm detected by a pressure sensor 62; signals indicative of brake pressures (wheel cylinder pressures) Pbi (i=fl, fr, rl, rr) on the respective wheels from the pressure sensors 64FL to 64RR; and signals indicative of a control stage Si (i=fl, fr, rl, rr) of the damping coefficient from the actuators of the shock absorbers 40FL to 40RR

The lateral acceleration sensor 52, the rotational angle sensors 54F and 54R, the yaw rate sensor 56, and the steering angle sensor 60 detect vehicle lateral acceleration Gy, rotational angles f f and f r, vehicle yaw rate γ, and steering angle θ, respectively, and represent values obtained upon left turning of the vehicle as positive values.

In accordance with the flowchart shown in FIG2, the ECU 50 calculates target brake pressures Pbti (i=fl, fr, rl, rr) of the wheel cylinders 32FL to 32RR based on the master cylinder pressure Pm during normal braking, and adjusts the brake pressures Pbi of the wheel cylinders 32FL to 32RR to the individually corresponding target brake pressures Pbti. In contrast, the ECU 50, in response to hard braking being applied by the driver, activates so-called brake assist control (simply referred to as BA control in the drawings) that presets the target wheel cylinder pressure Pbti on each wheel higher than the normal level. Then, in response to the hard braking being released by the driver, the ECU 50 finishes the brake assist control. As the brake assist control is not the principal subject of the invention, this control may be executed in any manner known in the art.

As in the methods known in the art, the ECU 50 estimates a vehicle slip angle β based on a vehicle state quantity, such as vehicle lateral acceleration Gy, which varies as the vehicle moves. Based on the deviation between a target vehicle slip angle βt and the estimated vehicle slip angle β, the ECU 50 calculates a spin state quantity SS, which indicates the degree of spinning of the vehicle. Concurrently, the ECU 50 calculates a drift state quantity DS, which indicates the degree of drifting of the vehicle, based on the deviation Δγ between an actual vehicle yaw rate γ and a target vehicle yaw rate γt corresponding to the steering angle θ. Then, the ECU 50 determines the behavior of the vehicle based on the spin state quantity SS and the drift state quantity DS. If the determination is made that the vehicle behavior is unstable, the ECU 50 executes vehicle dynamics (vehicle behavior) control to stabilize the turning motion of the vehicle. In this control, a target brake pressure Pbti on each wheel is calculated so as to generate a target yawing moment to return the vehicle to a stable running state, and the brake pressure Pbi on each wheel is then adjusted to the target brake pressure Pbti, so that a yawing moment occurs on the vehicle in the direction to suppress the spinning or drifting of the vehicle, while decelerating the vehicle.

Upon normal vehicle turning without hard braking, the ECU 50 estimates a roll moment that is acting on the vehicle based on the vehicle lateral acceleration Gy, and then calculates target roll stiffness of the front and rear wheels, although these steps are not shown in the flowchart. The ECU 50 then calculates the target rotational angles f ft and f rt of the actuators 20F and 20R of the active stabilizers 16 and 18 based on the roll moment and the target roll stiffness such that the anti-roll moment in the direction to cancel the roll moment increases. Thus, the actual rotational angles f f and f r of the actuators 20F and 20R are adjusted to the corresponding target rotational angles f ft and f rt, respectively, thereby reducing the vehicle roll during turning.

In contrast, during the brake assist control which has been activated in response to hard braking by the driver, the ECU 50 determines whether the driver is likely to perform steering operation. If the determination is made that the driver is likely to perform steering operation, the ECU 50 calculates an index value Ks that indicates the likelihood of steering operation by the drivel The ECU 50 then controls the active stabilizers 16 and 18 such that as the index value Ks increases, in other words, as there is a higher likelihood of steering operation by the driver, the roll stiffness allocation is biased towards the rear wheels, thereby varying the steering characteristic of the vehicle to increase oversteering component of the vehicle.

Thus, the active stabilizers 16 and 18, the ECU 50, and the lateral acceleration sensor 52 together serve as an anti-roll moment increase/decrease system for increasing the anti-roll moment to suppress vehicle roll when an excessive roll moment acts on the vehicle. Also, they may serve as mechanism for varying the steering characteristic of the vehicle.

Further, the ECU 50 controls the damping coefficient of each shock absorber 40FL to 40RR according to the vehicle speed V, such that, in the case of normal driving without hard braking, as the vehicle speed V increases, the damping coefficient of each shock absorber 40FL to 40RR increases, or in the case of vehicle turning or acceleration/deceleration, as the degree of turning or acceleration/deceleration increases, in other words, as the vehicle lateral acceleration or longitudinal acceleration increases, the damping coefficient of each shock absorber 40FL to 40RR increases.

If the determination is made that the driver is likely to perform steering operation, the ECU 50 controls the damping coefficient of each shock absorber 40FL to 40RR such that as the index value Ks that indicates the likelihood of steering operation increases, the compression damping coefficient of the shock absorber on the front wheel on the outside of the turn and the extension damping coefficient of the shock absorber on the front wheel on the inside of the turn decrease, while the compression damping coefficient of the shock absorber on the rear wheel on the outside of the turn and the extension damping coefficient of the shock absorber on the rear wheel on the inside of the turn increase. This encourages load transfer to the front wheel on the outside of the turn, while suppressing load transfer to the rear wheel on the outside of the urn, which varies the steering characteristic of the vehicle to increase oversteering component of the vehicle during turning. Note that, in the specification, “compression damping coefficient” represents the damping coefficient for damping during compression of each shock absorber, and “extension damping coefficient” represents the damping coefficient for damping during extension of each shock absorber. Also note that the front and rear wheels on the outside of a turn will be simply referred to as an “outside front wheel” and “outside rear wheel”, respectively, and the front and rear wheels on the inside of a turn will be simply referred to as an “inside front wheel” and “inside rear wheel”, respectively, where appropriate.

Thus, the shock absorbers 40FL to 40RR and the ECU 50 serve as an apparatus that suppresses attitude changes and vibrations of the vehicle body during middle and high speed driving while ensuring good ride comfort during low-speed driving and they may serve also as mechanism for varying the steering characteristic of the vehicle.

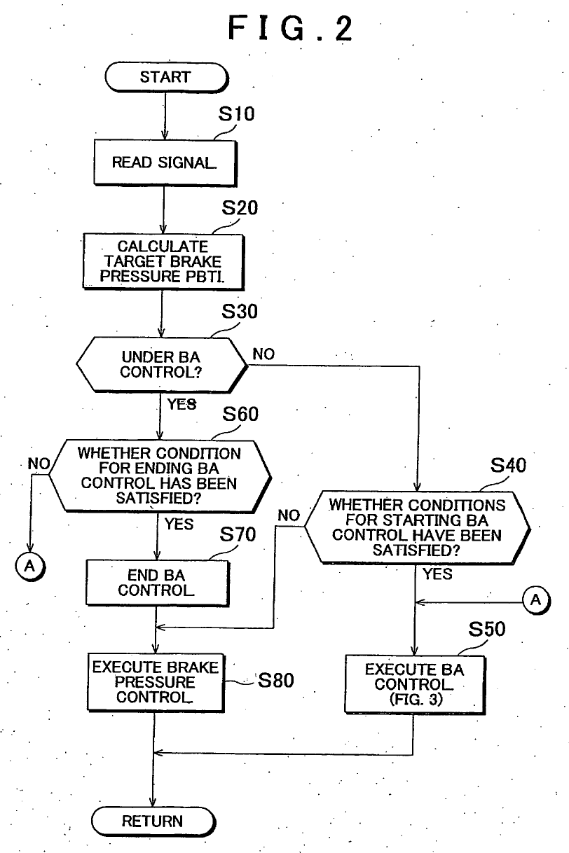

With reference to a flowchart of FIG. 2, a braking force control routine according the first embodiment will now be described below. The control illustrated in this flowchart is activated in response to an ignition switch (not shown) being turned on and is repeatedly executed at given time intervals.

Instep S10, a signal indicative of the master cylinder pressure Pm detected by the pressure sensor 62 is read. In step S20, a target brake pressure Pbti of each wheel cylinder 32FL to 32RR is calculated by multiplying a coefficient Kai (i=fl, fr, rl, rr) for each wheel with the master cylinder pressure Pm.

In step S30, a determination is made whether the brake assist control is presently executed. If the determination is YES, the process goes to step S60, or if NO, to step S40.

In step S40, a determination is made whether the conditions for starting the brake assist control have been satisfied. If the determination is NO, the process goes to step S80, or if YES, to step S50. The conditions for starting the brake assist control may include: (1) a vehicle speed V being equal to or grater than a reference value Vbas (positive constant); (2) a master cylinder pressure Pm being equal to or greater than a reference value Pmbas (positive constant); and (3) an increasing rate ΔPm of master cylinder pressure per unit time being equal to or greater than a reference value ΔPmbas (positive constant).

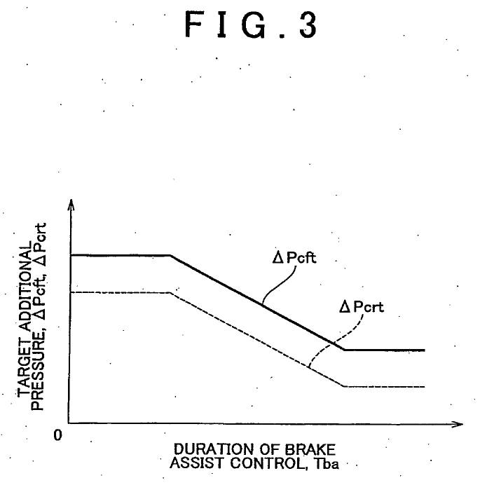

In step S50, the brake assist control is executed. The brake assist control may be executed in any manner known in the art. For example, independent of variations in master cylinder pressure Pm subsequent to the commencement of the brake assist control, target additional pressures ΔPcft and ΔPcrt are calculated based on the duration Tba of the brake assist control with reference to the map graph shown in FIG. 3. Then, the pressures, which are obtained by adding the target additional pressures ΔPcft and ΔPcrt respectively to the front and rear wheel cylinder pressures Pbi, are established as target wheel cylinder pressures Pbti. Thereby, the front and rear wheel brake pressures are adjusted to be higher than those at normal braking.

In step S60, a determination is made whether the condition for ending the brake assist control has been satisfied. If the determination is NO, the process goes to step S50, or if YES, to step S70. The condition for ending the brake assist control may be that (1) the vehicle is determined to have stopped based on the vehicle speed V or (2) the master cylinder pressure Pm is equal to or lower than a reference value Pmbae (positive constant) for the completion of the control.

In step S70, the brake assist control is ended. In step S80, the bring forces on the respective wheels are controlled by adjusting each wheel cylinder pressure Pbi to the corresponding target wheel cylinder pressure Pbti.

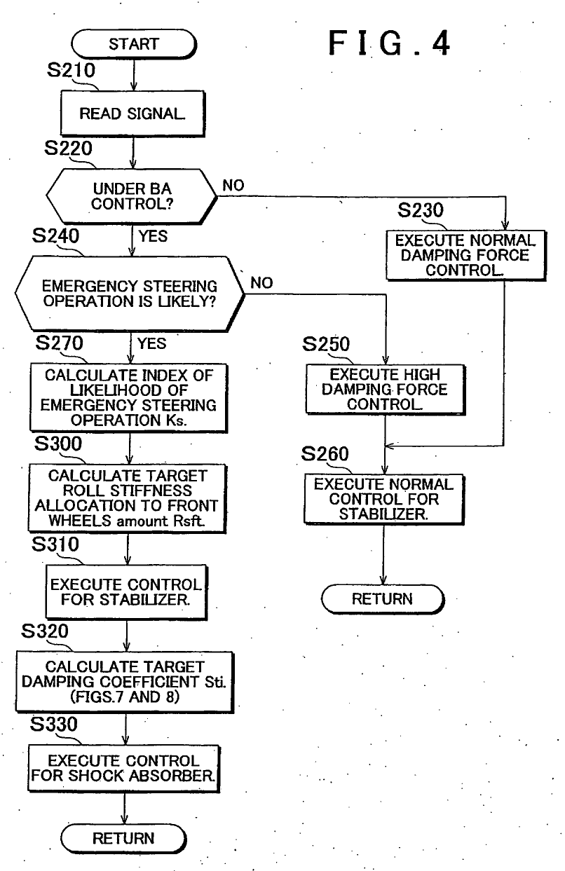

With reference to a flowchart of FIG. 4, a roll stiffness and damping force control routine according the first embodiment will now be described. The control illustrated in this flowchart is also activated in response to the ignition switch (not shown) being turned on and is repeatedly executed at given time intervals.

In step S210, a signal indicative of the vehicle speed V detected by the vehicle speed sensor 58 is read. In step S220, a determination is made whether the brake assist control is presently executed. If the determination is YES, the process goes to step S240, or if NO, to step S230 where the normal damping force control is executed for each shock absorber 40FL to 40RR as previously stated, and then to step S260.

In step S240, a determination is made whether the driver is likely to perform emergency steering operation. If the determination is YES, the process goes to step S270, or if NO, to step S250. In this situation, the determination may be made that the driver is likely to perform emergency steering operation, if the following conditions are satisfied: The vehicle speed V is equal to or greater than the reference value Vs (positive constant); the vehicle deceleration Gxb, which is obtained based on the rate of change in vehicle speed V or on the vehicle longitudinal acceleration Gx detected by a longitudinal acceleration sensor (not shown), is equal to or greater than a reference value Gxbs (positive constant); and the master cylinder pressure Pm is equal to or greater than a reference value Pms (positive constant).

In step S250, in order to suppress attitude changes of the vehicle body caused by load transfer to the vehicle front during braking, the target damping coefficient Sti of each shock absorber 40FL to 40RR is calculated so that Sti increases as the vehicle deceleration Gxb increases, and the damping coefficient Si of each shock absorber 40FL to 40RR is adjusted to the corresponding target damping coefficient Sti.

In step S260, the normal damping force control is executed for the active stabilizers 16 and 18 as previously noted. Then, the control illustrated in the flowchart of FIG. 4 is ended temporarily.

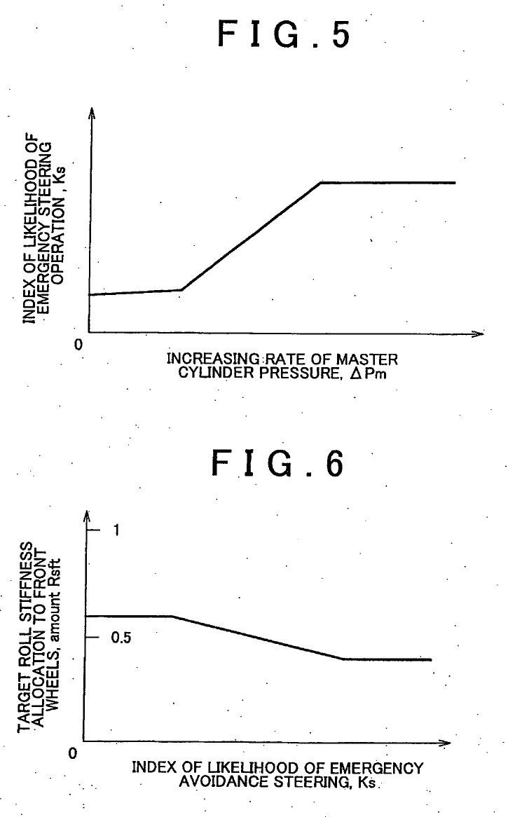

In step S270, the increasing rate ΔPm of master cylinder pressure Pm per unit time is calculated, and based on the increasing rate ΔPm of master cylinder pressure, the index value Ks that indicates the likelihood of emergency steering operation by the driver is calculated with reference to the map graph shown in FIG. 5. In step S300, based on the index value Ks, a target roll stiffness allocation amount Rsft to the front wheels is calculated with reference to the map graph of FIG. 6 such that a target roll stiffness allocation amount Rsft to the front wheels decreases as the index value Ks increases.

In step S310, the roll moment acting on the vehicle is estimated based on at least the vehicle lateral acceleration Gy. If the magnitude of the roll moment is equal to or greater than a reference value, a target vehicle anti-roll moment Mat is calculated so as to increase the anti-roll moment in the direction to cancel the roll moment. Based on the target anti-roll moment Mat and the target roll stiffness allocation amount Rsft to the front wheels, target front and rear wheel anti-roll moments Matf and Matr are calculated. Based on the target anti-roll moments Matf and Matr, target rotational angles f ft and f rt of the actuators 20F and 20R of the active stabilizers 16 and 18 are calculated, after which the rotational angles f f and f r of the actuators 20F and 20R are adjusted to the corresponding target rotational angles f ft and f rt, respectively.

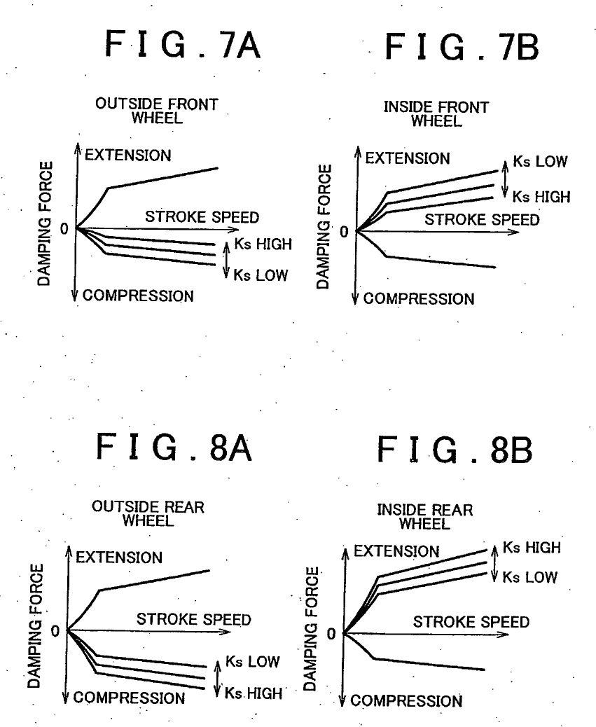

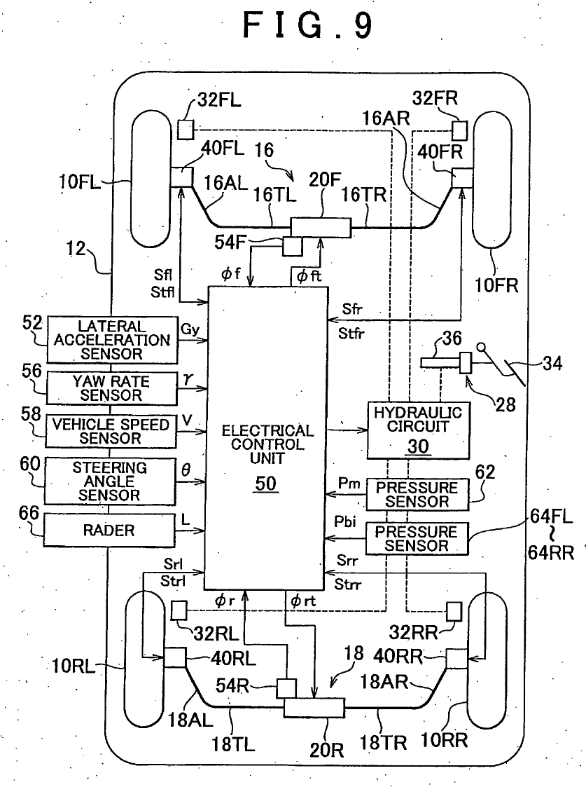

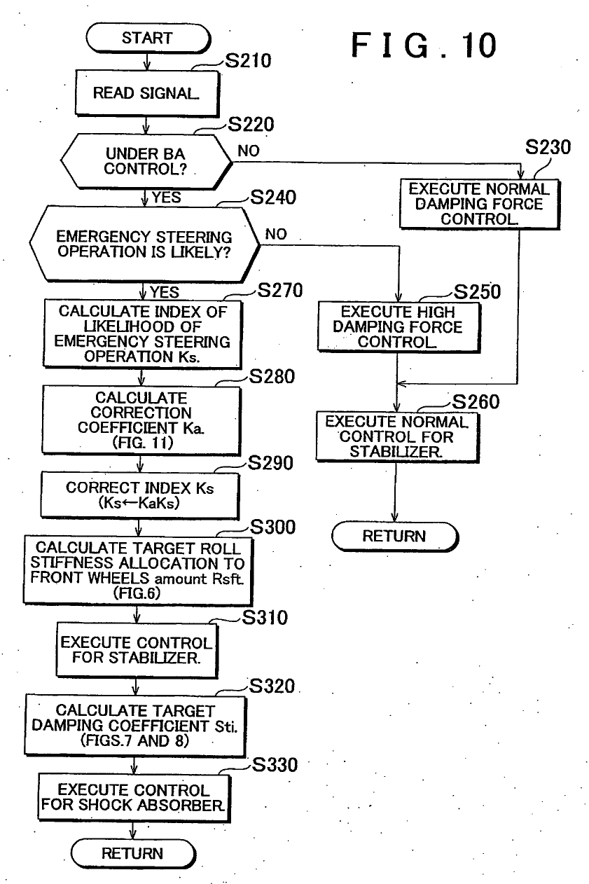

In step S320, the direction in which the vehicle is turning is determined based on the vehicle lateral acceleration Gy or the vehicle yaw rate γ. A target damping coefficient Sti of each shock absorber 40FL to 40RR is calculated as shown in FIGS. 7 and 8. FIG. 7 represents that, as the index value Ks indicating as the likelihood of steering operation increases, the compression damping coefficient of the shock absorber on the outside front wheel and the extension damping coefficient of the shock absorber on the inside front wheel both decrease. FIG. 8 represents that as the index value Ks increases, the compression damping coefficient of the shock absorber on the outside rear wheel and the extension damping coefficient of the shock absorber on the inside rear wheel increase. In step S330, the damping coefficient Si of each shock absorber 40FL to 40RR is adjusted to the corresponding target damping coefficient Sti.

Therefore, according to the illustrated first embodiment, if the determination is made in step S220 that the brake assist control is presently executed, and then in step S240 that the driver is likely to perform emergency steering operation, the index value Ks is calculated based on the increasing rate ΔPm of master cylinder pressure in step S270, such that the larger the increasing rate ΔPm of master cylinder pressure, the larger the index value Ks. In step S300, target roll stiffness allocation amount Rsft to the front wheels is calculated based on the index value Ks such that the lager the index value Ks, the smaller the target roll stiffness allocation amount Rsft to the front wheels.

In step S310, a target vehicle anti-roll moment Mat is calculated so as to increase the anti-roll moment in the direction to cancel the roll moment. Based on the target anti-roll moment Mat and the target roll stiffness allocation amount Rsft to the front wheels, target front and rear wheel anti-roll moments Matf and Matr are calculated. Based on the target anti-roll moments Matf and Matr, the active stabilizers 16 and 18 are controlled, such that as the index value Ks increases, the roll stiffness allocation is biased to the rear wheels, in other words, as there is a higher likelihood emergency steering operation by the driver, the steering characteristic of the vehicle is varied to increase oversteering component of the vehicle.

Thus, according to the illustrated first embodiment, when the likelihood of emergency steering operation by the driver is high during hard braking, the steering characteristic of the vehicle is reliably varied to increase oversteering component of the vehicle so that it becomes greater than it is when the likelihood of emergency steering operation by the driver is low. Thus, the vehicle can turn easily without reducing the braking forces on the wheels, even when the driver is performing emergency steering operation during hard braking. Therefore, upon the driver's emergency steering operation during hard braking, the vehicle can be turned as much as intended by the driver while being braked as required by the driver.

In addition, according to the illustrated first embodiment, a determination is made whether the driver is likely to perform emergency steering operation. If the likelihood of emergency steering operation by the driver is high, the steering characteristic of the vehicle is varied to increase oversteering component of the vehicle so that it becomes greater than it is when the likelihood is low. Thus, the steering characteristic of the vehicle can be reliably varied to increase oversteering component of the vehicle without a response delay, unlike the case where the steering characteristic of the vehicle is varied to increase oversteering component of the vehicle in response to emergency steering operation by the driver being detected from, for example, changes in the steering angle.

According to the illustrated first embodiment, in step S300, the target roll stiffness allocation amount Rsft to the front wheels is calculated such that the larger the index value Ks indicating the likelihood of emergency steering operation by the driver, the smaller the target roll stiffness allocation amount Rsft. Therefore, as there is a higher likelihood of emergency steering operation by the driver, the steering characteristic of the vehicle is varied to increase oversteering component of the vehicle, thereby making it easier for the vehicle to be turned.

Further, according to the illustrated first embodiment, if it is determined in step S220 that the brake assist control is presently executed and then in step S240 that the driver is likely to perform emergency steering operation, the steering characteristic of the vehicle is controlled in the manner previously noted. Not only that, the damping coefficient Si of each shock absorber 40FL to 40RR is also controlled in the steps S320 and S330, such that as the index value KS indicating the likelihood of emergency steering operation increases, the compression damping coefficient of the shock absorber on the outside front wheel and the extension damping coefficient of the shock absorber on the inside front wheel both decrease and the compression damping coefficient of the shock absorber on the outside rear wheel and the extension damping coefficient of the shock absorber on the inside rear wheel increase.

Thus, compared to the case where the damping coefficients of the left and right front wheel shock absorbers 40FL and 40FR are not controlled in the manner as described above, the vehicle height at the outside front wheel is lowered, and therefore the difference in height between the roll center at the front wheels and the center of gravity of the vehicle increases. Thus, if the vehicle is turned in this state, a larger roll moment occurs at the front wheels, which increases the contact force on the outside front wheel and reduces the contact force on the inside front wheel, thus enabling a larger amount of lateral force to be produced at the outside front wheel, and which also reduces the braking force on the inside front Wheel and thus causes a difference in braking force between the left and right front wheels. This difference in braking force causes a yawing moment to occur in the direction to assist the vehicle to turn. Accordingly, the driver can steer the vehicle more easily during turning of the vehicle, especially in the initial stage of the steering operation.

Further, as compared to the case where the damping coefficients of the left and right rear wheel shock absorbers 40RL and 40RR are not controlled in the manner as described, the decrease in vehicle height at the outside rear wheel is suppressed, and therefore an increase in the difference in height between the roll center at the rear wheels and the center of gravity of the vehicle is suppressed, and accordingly an increase in the roll moment at the rear wheels is suppressed. Thus, load transfer from the inside rear wheel to the outside rear wheel decreases, which suppresses an increase in the lateral force produced by the outside rear wheel. Accordingly, the driver can steer the vehicle more easily during turning of the vehicle, especially in the initial stage of the steering operation.

According to the illustrated first embodiment, moreover, the roll stiffness allocation is biased towards the rear wheels by reducing the roll stiffness at the front wheels and increasing the roll stiffness at the rear wheels, and therefore the steering characteristic of the vehicle can be varied to increase oversteering component of the vehicle in response to a higher likelihood of emergency steering operation by the driver while maintaining the entire vehicle roll stiffness unchanged. As such, it is possible to obtain greater effects of the control of the damping coefficients of the shock absorbers, as compared to, for example, the case where the roll stiffness allocation is biased towards the rear wheels by increasing the roll stiffness at the rear wheels without reducing the roll stiffness of the front wheels.

According to the illustrated first embodiment, further, unless it is determined in step S240 that the driver is likely to perform emergency steering operation, the processes from step S270 onward are not executed even when it has been determined in step S220 that the brake assist control is presently executed. Thus, when the likelihood of emergency steering operation following hard braking operation is low, the steering characteristic of the vehicle is not varied to increase oversteering component of the vehicle unnecessarily and therefore reduction of the driving stability of the vehicle, which may otherwise be caused, can be prevented.

Note that, in the illustrated first embodiment, when the vehicle behavior becomes unstable, the braking forces on the respective wheels are controlled to stabilize the vehicle behavior. Thus, even when the vehicle behavior has become unstable as a result of the control of the roll stiffness allocation between the front and rear wheels or the control of damping coefficients of the shock absorbers, the vehicle behavior can be returned to a stable state effectively.

FIG. 9 is a schematic diagram of a vehicle drive control according to the second embodiment of the invention. In FIG. 9, components corresponding to those in FIG. 1 are denoted by the same reference numerals and symbols as in FIG. 1.

According to the second embodiment, a radar 66 is provided for detecting an obstacle in front of the vehicle and a distance L between the vehicle and the obstacle. A signal indicative of the distance L is inputted to the ECU 50. Based on the presence or absence of an obstacle and the distance L, the ECU 50 determines whether the driver is likely to perform emergency steering operation, and calculates a potential time Tc until the vehicle collides with the obstacle. The time Tc is obtained from the following equitation 1 representing the relationship between distance L, vehicle speed V, vehicle deceleration Gxb, and time Tc. The ECU 50 calculates a correction coefficient Ka such that the shorter the time Tc, the larger the coefficient Ka. Then, an index value Ks, which indicates the likelihood of emergency steering operation and is obtained in the same manner as the first embodiment, is corrected by being multiplied with the calculated correction coefficient Ka.
L=VTc+(GxbTc2)/2 (1)

Although not shown in the drawings, the braking force control is executed in accordance with the control routine shown in FIG. 2, as in the case of the first embodiment.

With reference to a flowchart of FIG. 10, a roll stiffness and damping force control routine according the second embodiment will now be described. In FIG. 10, steps corresponding to those in FIG. 4 are denoted by the same step numbers as in FIG. 4.

According to the second embodiment, the steps S210 to S230, S250 to S270, and S300 to S330 are executed in the same manner as the first embodiment In step S240 for determining whether the driver is likely to perform emergency steering operation, if the conditions are met: e.g. a vehicle speed V, vehicle deceleration Gxb and a master cylinder pressure Pm are equal to or greater than respective reference values Vs, Gsbs and Pms; and there is an obstacle in front of the vehicle, then the determination is YES, that is, it is determined that the driver is likely to perform emergency steering operation.

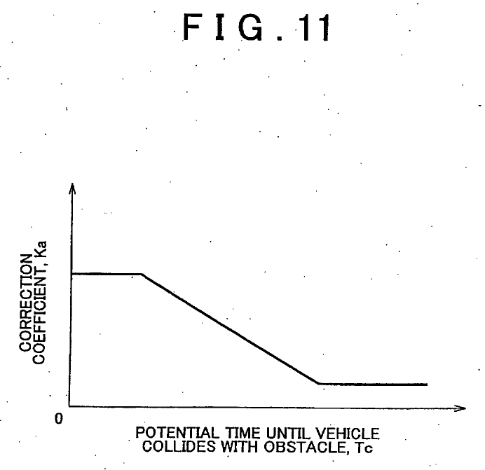

After step S270 is completed, the potential time Tc until the vehicle collides with the obstacle is calculated based on the aforementioned equitation 1, and then the correction coefficient Ka is calculated based on the time Tc with reference to the map graph shown in FIG. 11 in step S280. In step S290, the index value Ks that indicates the likelihood of emergency steering operation is multiplied by the correction coefficient Ka Then, the steps S300 to S330 are executed based on the corrected index value Ks.

Thus, according to the illustrated second embodiment, the effects, which are the same as those in the first embodiment, are achieved, and whether the driver is likely to perform emergency steering operation can be determined more accurately than it is in the first embodiment. According to the second embodiment, therefore, it is possible to more reliably avoid varying the steering characteristic of the vehicle to increase oversteering component of the vehicle unnecessarily, which may otherwise reduce the driving stability of the vehicle, when the likelihood of emergency steering operation by the driver is low.

According to the illustrated second embodiment, as described above, step S280 is executed which calculates the potential time Tc until the vehicle collides with an obstacle and calculates the correction coefficient Ka such that the shorter the time Tc, the larger the coefficient Ka, and step S290 is then executed which corrects the index value Ks, which indicates the likelihood of emergency steering operation, by multiplying it with the correction coefficient Ka, and the steps S300 to S330 are executed based on the corrected index value Ks. Thus, it is possible to calculate the index value Ks, which indicates the likelihood of emergency steering operation, more accurately according to the likelihood of emergency steering operation in an attempt to avoid an obstacle in front of the vehicle. Accordingly, as compared to the first embodiment, it is possible to more appropriately control the roll stiffness allocation between the front and rear wheels and the damping coefficients of the shock absorbers according to the likelihood of emergency steering operation by the driver.

Although the detailed descriptions of the specific embodiments of the invention have been provided, the invention is not limited to the aforementioned embodiments, but various other embodiments may also be allowed without departing the scope of the invention.

For example, in the aforementioned embodiments, the roll stiffness allocation is biased to the rear wheels by reducing the roll stiffness at the front wheels and increasing the roll stiffness at the rear wheels. Alternatively, the roll stiffness allocation may be biased towards the rear wheels either by reducing the roll stiffness at the front wheels through control of the front active stabilizer without increasing the roll stiffness at the rear wheels or by increasing the roll stiffness at the rear wheels through control of the rear stabilizer without reducing the roll stiffness at the front wheels.

Also, in the aforementioned embodiments, the brake assist control is activated in response to hard braking being applied by the driver, and if it is determined in step S220 that the brake assist control is presently executed, then whether the driver is likely to perform emergency steering operation is determined in step S240. Meanwhile, when the drive control device of the invention is applied to a vehicle that does not perform brake assist control, instead of the determination made in step S220, whether the driver is applying hard braking may be determined based on the master cylinder pressure Pm or increasing rate ΔPm thereof.

In the aforementioned embodiments, the shock absorbers according to the aforementioned embodiments are variable damping force shock absorbers, and if it is determined that the driver is likely to perform emergency steering operation, then the damping coefficient of each shock absorber is controlled in the manner previously stated. However, when the drive control system of the invention is applied to a vehicle provided with non-variable damping force shock absorbers, the steps S320 and S330 are omitted.

Further, in the aforementioned embodiments, the front and rear stabilizers, which are active stabilizers, are used to vary the roll stiffness allocation between the front and rear wheels. Alternatively, any device known in the art, such as active suspension, may be used as a device for increasing and reducing the roll stiffness.

In the second embodiment, the radar 66 is employed as a device for detecting an obstacle in front of the vehicle and the distance L between the vehicle and the obstacle. Alternatively, any device known in the art, such as CCD camera, may be used.

In the case where the drive control system of the invention is applied to a vehicle equipped with a power steering apparatus, when it is determined that the driver is likely to perform emergency steering operation, the steering characteristic of the vehicle may be varied to increase oversteering component of the vehicle by adjusting the steering assist torque produced by the power steering apparatus to be greater than the normal level. In addition, in the case where the drive control system of the invention is applied to a vehicle equipped with a variable steering gear ratio apparatus, if it is determined that the driver is likely to perform emergency steering operation, the steering characteristic of the vehicle may be varied to increase oversteering component of the vehicle by reducing the steering gear ratio.

While the invention has been described with reference to embodiments thereof, it is to be understood that the invention is not limited to the embodiments or constructions. To the contrary, the invention is intended to cover various modifications and equivalent arrangements. In addition, while the various elements of the embodiments are shown in various combinations and configurations, which are exemplary, other combinations and configurations, including more, less or only a single element, are also within the spirit and scope of the invention.

What is claimed is:

1. A drive control system for a vehicle, comprising
a braking force control mechanism that controls at least braking forces on steered wheels according to a braking operation;
a steering characteristic control mechanism that varies a steering characteristic of the vehicle;
a determination portion that determines whether an emergency steering operation is likely to be performed when hard braking is being applied; and
a main control portion that controls the steering characteristic control mechanism so as to vary the steering characteristic of the vehicle to be increase oversteering component of the vehicle if the determination portion determines that an emergency steering operation is likely to be performed.

2. The drive control system according to claim 1, wherein
the steering characteristic control mechanism includes a roll stiffness allocation control mechanism that changes a roll stiffness allocation between front wheels and rear wheels of the vehicle, and
if the determination portion determines that an emergency steering operation is likely to be performed, the main control portion controls the roll stiffness allocation control mechanism so that the roll stiffness allocation between the front wheels and the rear wheels is biased towards the rear wheels, as compared to when the determination portion determines that an emergency steering operation is not likely to be performed.

3. The drive control system according to claim 2, wherein
the roll stiffness allocation control mechanism includes a front stabilizer that applies a torsional stress to the front wheels and is capable of changing the magnitude of the torsional stress to the front wheels and a rear stabilizer that applies a torsional stress to the rear wheels and is capable of changing the magnitude of the torsional stress to the rear wheels, and
the control portion biases the roll stiffness allocation between the front wheels and the rear wheels towards the rear wheels by reducing the torsional stress to the front wheels through control of the front stabilizer.

4. The drive control system according to claim 1, wherein
the steering characteristic control mechanism includes damping force changing devices provided for the front and rear wheels, respectively, and
if the determination portion determines that an emergency steering operation is likely to be performed, the main control portion controls the damping force changing device provided for the front wheel on the outside of a turn of the vehicle so as to make a damping coefficient for the same front wheel smaller than when the determination portion determines that an emergency steering operation is not likely to be performed.

5. The drive control system according to claim 3, wherein
the determination portion determines whether an emergency steering operation is likely to be performed, based on a pressure of a master cylinder that changes in response to a brake control portion being operated.

6. The drive control system according to claim 5, further comprising:
an index value calculation portion that calculates an index value indicating the likelihood of an emergency steering operation; and
a first memory portion that stores a relationship between the index value and the pressure of the master cylinder, wherein
the main control portion obtains the index value based on the pressure of the master cylinder with reference to the relationship stored in the first memory, and determines the roll stiffness allocation between the front wheels and the rear wheels based on the obtained index value.

7. The drive control system according to claim 6, further comprising:
a time estimation portion that estimates a time until the vehicle collides with an obstacle; and
a second memory portion that stores a relationship between the time estimated by the time estimation portion and a correction coefficient used to correct the index value, wherein
the main control portion obtains the correction coefficient based on the time estimated by the time estimation portion with reference to the relationship stored in the second memory portion and changes the index value using the obtained correction coefficient.

8. A drive control method for a vehicle in which at least braking forces on a steered wheel are controlled according to a braking operation and the steering characteristic of the vehicle is varied, comprising:
determining whether an emergency steering operation is likely to be performed when hard braking is being applied; and
varying the steering characteristic of the vehicle to increase oversteering component of the vehicle if it is determined that an emergency steering operation is likely to be performed.

9. The drive control method according to claim 8, wherein
the steering characteristic of the vehicle is varied to increase oversteering component of the vehicle by biasing a roll stiffness allocation between front wheels and rear wheels of the vehicle towards the rear wheels.

10. The drive control method according to claim 9, wherein
the roll stiffness allocation is biased towards the rear wheels by reducing a torsional stress applied from a front stabilizer, which is capable of changing the magnitude of the torsional stress, to the front wheels.

11. The drive control method according to claim 8, wherein
when it is determined that an emergency steering operation is likely to be performed, a damping coefficient for the front wheel on the outside of a turn of the vehicle is made smaller than when it is determined that an emergency steering operation is not likely to be performed.
